(19) United States
(12) Patent Application Publication
(10) Pub. No.: US 2021/0208602 A1
(43) Pub. Date: Jul. 8, 2021

(54) AERIAL CONTROL SYSTEM

(71) Applicant: LG ELECTRONICS INC., Seoul (KR)

(72) Inventors: Seokhee YI, Seoul (KR); Nakyeong KIM, Seoul (KR)

(73) Assignee: LG ELECTRONICS INC., Seoul (KR)

(21) Appl. No.: 16/499,817

(22) PCT Filed: Jul. 12, 2019
(86) PCT No.: PCT/KR2019/008640

§ 371 Date: Sep. 30, 2019

(51) Int. Cl. G05D 1/04; G05D 1/00; B64C 13/18

(52) U.S. Cl. CPC G05D 1/042; B64C 13/18; G05D 1/0011; G05D 1/0055

(57) ABSTRACT

The present invention is characterized to store information on a flight restricted area in which a flight of an unmanned aerial vehicle is restricted, differently calculate an access limit distance of the flight restricted area depending on an autonomous flying level of the unmanned aerial vehicle, and provide at least one of the unmanned aerial vehicle and a terminal with the information on the flight restricted area and information on the access limit distance. The present invention can control a drone or a robot through 5G communication and improve artificial intelligence and an autonomous flying performance of the drone or the robot.

### TECHNICAL FIELD

The present invention relates to an aerial control system of an unmanned aerial vehicle, and more particularly to an aerial control system for appropriate flying and control depending on an autonomous flying level of an unmanned aerial vehicle.

### BACKGROUND ART

An unmanned aerial vehicle generally refers to an aircraft and a helicopter-shaped unmanned aerial vehicle/uninhabited aerial vehicle (UAV) capable of a flight and pilot by the induction of a radio wave without a human pilot. The unmanned aerial vehicle is recently increasingly used in various civilian and commercial fields, such as image photographing, unmanned delivery service, and disaster observation, in addition to military use such as reconnaissance and an attack.

Unmanned aerial vehicles for civilian and commercial use should be restrictively operated because construction of foundation such as various regulations, authentication and a legal system is insufficient, and it is difficult for users of unmanned aerial vehicles to recognize potential dangers or dangers that can be posed to public. Particularly, occurrence of collision accidents, flight over security areas, invasion of privacy and the like tends to increase due to indiscreet use of unmanned aerial vehicles.

Many countries are trying to improve new regulations, standards, policies and procedures with respect to operation of unmanned aerial vehicles.

In Korea, owners of ultralight flying devices are required to report it to the Ministry of Land, Infrastructure and Transport, except for non-business unmanned aerial vehicles less than 12 kg. The unmanned aerial vehicles can fly in most parts of Seoul at altitudes equal to or less than 150 m, except for a flight prohibited area and a flight restricted area near the military demarcation line (MDL). The unmanned aerial vehicles can also fly even in the flight prohibited area or the flight restricted area if approved in advance.

Various techniques have been proposed for air traffic control of unmanned aerial vehicles. Korean Patent No. 10-0954500 entitled “Air traffic control system of unmanned aerial vehicle” is configured to perform wireless communication using a unmanned aerial vehicle, on which a wireless transceiver and a code division multiple access (CDMA) modem are mounted, and a wireless communication device and control the unmanned aerial vehicle by a ground control equipment performing the wireless communication using the unmanned aerial vehicle and a CDMA communication network.

However, the related art merely controls the unmanned aerial vehicle based on only the flight restricted area, and does not perform various controls corresponding to an autonomous flying level of the unmanned aerial vehicle, thereby having a problem of only consistent control.

Such a consistent control has problems that a unmanned aerial vehicle cannot fly by the control of a server if the unmanned aerial vehicle has a low autonomous flying level, and a flight efficiency of a unmanned aerial vehicle may be reduced due to an increase in a flying path if the unmanned aerial vehicle has a high autonomous flying level.

### DISCLOSURE

### Technical Problem

A first object of the present invention is to provide an aerial control system providing a flight restricted area and an access limit distance corresponding to an autonomous flying level by determining the autonomous flying level of an unmanned aerial vehicle.

A second object of the present invention is to provide an aerial control system that provides various flight paths near a flight restricted area correspondingly to an autonomous flying level of an unmanned aerial vehicle and enables the unmanned aerial vehicle to fly along the various flight paths.

A third object of the present invention is to provide an aerial control system providing a user with an avoidance path near the flight restricted area and an access alarm of a flight restricted area correspondingly to an autonomous flying level of an unmanned aerial vehicle.

A fourth object of the present invention is to provide an aerial control system that allows an unmanned aerial vehicle to approach within an access limit distance depending on a level of a user when the unmanned aerial vehicle is manually adjusted.

### Technical Solution

To solve the above-described and other problems, the present invention is configured to differently calculate an access limit distance of a flight restricted area depending on an autonomous flying level of an unmanned aerial vehicle and provide at least one of the unmanned aerial vehicle and a terminal with information on the flight restricted area and information on the access limit distance.

Specifically, the present invention comprises an unmanned aerial vehicle, a communication module configured to exchange information with the unmanned aerial vehicle, a level determination module configured to determine an autonomous flying level of the unmanned aerial vehicle, a storing module configured to store information on a flight restricted area in which a flight of the unmanned aerial vehicle is restricted, and a control module configured to differently calculate an access limit distance of the flight restricted area depending on the autonomous flying level of the unmanned aerial vehicle and provide the unmanned aerial vehicle with the information on the flight restricted area and information on the access limit distance.

The access limit distance may be set to decrease as the autonomous flying level increases.

The access limit distance may be differently set depending on a type or a location of the flight restricted area.

The unmanned aerial vehicle may set a flight path based on the information on the flight restricted area and the information on the access limit distance.

The present invention may further comprise a location determination module configured to determine a location and an altitude of the unmanned aerial vehicle through location altitude information provided by the unmanned aerial vehicle.

If the unmanned aerial vehicle approaches within the access limit distance, the control module may send a different command to the unmanned aerial vehicle depending on the autonomous flying level.

If the unmanned aerial vehicle approaches within the access limit distance, the control module may send a flying command that allows the unmanned aerial vehicle to fly along a new flight path out of the access limit distance when the autonomous flying level exceeds a predetermined level.

If the unmanned aerial vehicle approaches within the access limit distance, the control module may control the unmanned aerial vehicle to move to a location farther than the access limit distance in the flight restricted area when the autonomous flying level is equal to or less than a predetermined level.

The present invention may further comprise a terminal configured to exchange information with the unmanned aerial vehicle and the communication module and control the unmanned aerial vehicle.

If the unmanned aerial vehicle approaches within the access limit distance, the control module may control the terminal to output an access alarm of the flight restricted area.

If the unmanned aerial vehicle approaches within the access limit distance, the control module may control the terminal to output a deviation path of the flight restricted area.

The level determination module may determine an automatic adjustment or a manual adjustment of the unmanned aerial vehicle. If the unmanned aerial vehicle approaches within the access limit distance, the control module may control the terminal to output an access alarm of the flight restricted area in case of the manual adjustment.

The level determination module may determine an automatic adjustment or a manual adjustment of the unmanned aerial vehicle. The control module may allow the unmanned aerial vehicle to approach within the access limit distance depending on a level of a user in case of the manual adjustment.

If the unmanned aerial vehicle approaches within the access limit distance, the control module may control the unmanned aerial vehicle to be forced to land when the level of the user is equal to or less than a predetermined level in the case of the manual adjustment.

The present invention may comprise an unmanned aerial vehicle, a server configured to exchange information with the unmanned aerial vehicle, and a terminal configured to exchange information with the unmanned aerial vehicle and the server and control the unmanned aerial vehicle, wherein the server may be configured to store information on a flight restricted area in which a flight of the unmanned aerial vehicle is restricted, differently calculate an access limit distance of the flight restricted area depending on an autonomous flying level of the unmanned aerial vehicle, and provide at least one of the unmanned aerial vehicle and the terminal with the information on the flight restricted area and information on the access limit distance.

The server may be configured to set a flight path based on the information on the flight restricted area and the information on the access limit distance and provide the flight path to at least one of the unmanned aerial vehicle and the terminal.

### Advantageous Effects

The present invention can increase an access limit distance of a flight restricted area in case of a low autonomous flying level or manual adjustment, and can decrease the access limit distance of the flight restricted area in case of a high autonomous flying level. Therefore, the present invention allows an unmanned aerial vehicle with the high autonomous flying level to approach near a boundary of the flight restricted area and thus can fly the unmanned aerial vehicle along an effective path by approaching the unmanned aerial vehicle with the high autonomous flying level up to the boundary of the flight restricted area. Further, the present invention can prevent accidents that may occur when the unmanned aerial vehicle with the low autonomous flying level approaches the flight restricted area by increasing the access limit distance of the flight restricted area of the unmanned aerial vehicle with the low autonomous flying level.

The present invention provides a user of an unmanned aerial vehicle with information on a flight restricted area and information on an access limit distance and thus can help the user to set or adjust a path of the unmanned aerial vehicle.

The present invention provides a user with an avoidance path near a flight restricted area and an access alarm of the flight restricted area according to an autonomous flying level of an unmanned aerial vehicle, and thus the user can fly the unmanned aerial vehicle by avoiding the flight restricted area by checking the alarm.

The present invention provides a new path for a destination according to an autonomous flying level of an unmanned aerial vehicle or controls to deviate an access limit distance if the unmanned aerial vehicle approaches the access limit distance, and thus can prevent the unmanned aerial vehicle from approaching within the access limit distance in advance.

### DESCRIPTION OF DRAWINGS

FIG. 1 is a perspective view of an unmanned aerial vehicle according to an embodiment of the present invention.

FIG. 2 is a block diagram illustrating a control relation between major configurations of the unmanned aerial vehicle of FIG. 1.

FIG. 3 is a block diagram illustrating a control relation between major configurations of an aerial control system according to an embodiment of the present invention.

FIG. 4 illustrates a block configuration diagram of a wireless communication system to which methods proposed by the present specification are applicable.

FIG. 5 illustrates an example of a signal transmission/reception method in a wireless communication system.

FIG. 6 illustrates an example of a basic operation of a robot and a 5G network in a 5G communication system.

FIG. 7 illustrates an example of a basic operation between robots using 5G communication.

FIG. 8 illustrates an example of a conceptual diagram of a 3GPP system including a UAS.

FIG. 9 illustrates examples of a C2 communication model for a UAV.

FIG. 10 is a flow chart illustrating an example of a measurement execution method to which the present invention is applicable.

FIG. 11 is a conceptual diagram illustrating a flight restricted area and an access limit distance.

FIG. 12 is a figure illustrating a flying path according to an autonomous flying level of an unmanned aerial vehicle.

FIG. 13 is another figure illustrating a flying path according to an autonomous flying level of an unmanned aerial vehicle.

FIG. 14 is another figure illustrating a flying path according to an autonomous flying level of an unmanned aerial vehicle.

FIG. 15 is a flow chart illustrating a method of controlling an aerial control system according to a first embodiment of the present invention.

FIG. 16 is a flow chart illustrating a method of controlling an aerial control system according to a second embodiment of the present invention.

FIG. 17 is a flow chart illustrating a method of controlling an aerial control system according to a third embodiment of the present invention.

FIG. 18 is a flow chart illustrating an example of an operation method of an unmanned aerial vehicle for control of an aerial control system proposed by the present specification.

FIG. 19 illustrates a block configuration diagram of a wireless communication device according to an embodiment of the present invention.

FIG. 20 illustrates a block configuration diagram of a communication device according to an embodiment of the present invention.

### MODE FOR INVENTION

It is noted that technical terms used in this specification are used to explain a specific embodiment and are not intended to limit the present invention. In addition, technical terms used in this specification agree with the meanings as understood by a person skilled in the art unless defined to the contrary and should be interpreted in the context of the related technical writings not too ideally or impractically.

Furthermore, if a technical term used in this specification is an incorrect technical term that cannot correctly represent the spirit of the present invention, this should be replaced by a technical term that can be correctly understood by those skill in the air to be understood. Further, common terms as found in dictionaries should be interpreted in the context of the related technical writings not too ideally or impractically unless this disclosure expressly defines them so.

Further, an expression of the singular number may include an expression of the plural number unless clearly defined otherwise in the context. The term “comprises” or “includes” described herein should be interpreted not to exclude other elements or steps but to further include such other elements or steps since the corresponding elements or steps may be included unless mentioned otherwise.

In addition, it is to be noted that the suffixes of elements used in the following description, such as a “module” and a “unit”, are assigned or interchangeable with each other by taking into consideration only the ease of writing this specification, but in themselves are not particularly given distinct meanings and roles.

Further, terms including ordinal numbers, such as the first and the second, may be used to describe various elements, but the elements are not restricted by the terms. The terms are used to only distinguish one element from the other element. For example, a first component may be called a second component and the second component may also be called the first component without departing from the scope of the present invention.

Hereinafter, preferred embodiments according to the present invention are described in detail with reference to the accompanying drawings. The same reference numerals are assigned to the same or similar elements regardless of their reference numerals, and redundant descriptions thereof are omitted.

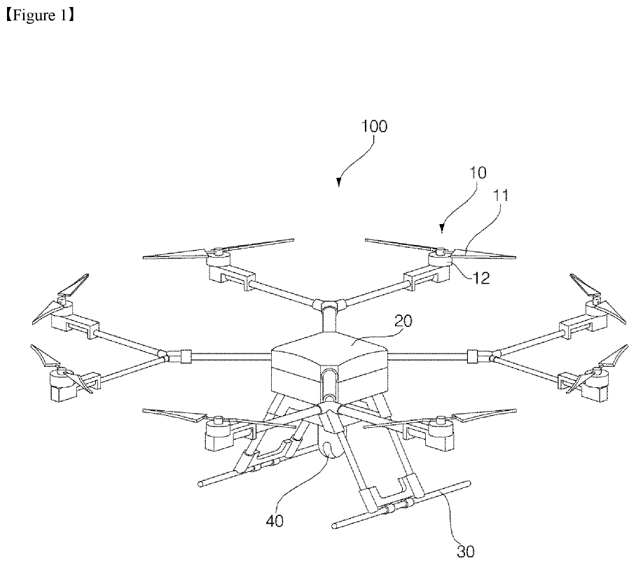

FIG. 1 shows a perspective view of an unmanned aerial robot according to an embodiment of the present invention.

First, the unmanned aerial vehicle 100 is manually manipulated by an administrator on the ground, or it flies in an unmanned manner while it is automatically piloted by a configured flight program. The unmanned aerial vehicle 100, as in FIG. 1, is configured with a main body 20, the horizontal and vertical movement propulsion device 10, and landing legs 130.

The main body 20 is a body portion on which a module, such as a task unit 40, is mounted.

The horizontal and vertical movement propulsion device 10 is configured with one or more propellers 11 positioned vertically to the main body 20. The horizontal and vertical movement propulsion device 10 according to an embodiment of the present invention includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30. The unmanned aerial vehicle 100 may have various aerial vehicle structures different from that described above.

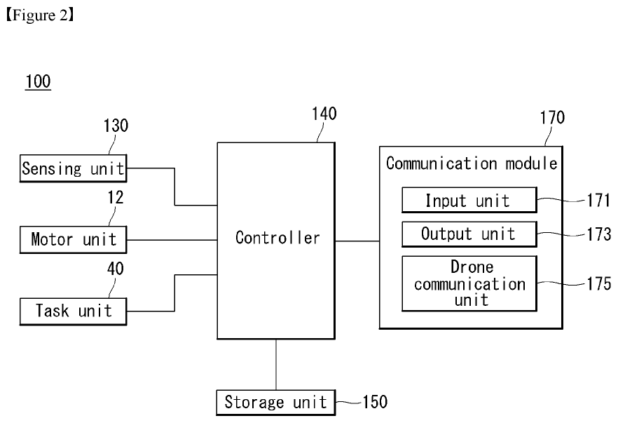

Referring to FIG. 2, the unmanned aerial vehicle 100 measures its own flight state using a variety of types of sensors in order to fly stably. The unmanned aerial vehicle 100 may include a sensing unit 130 including at least one sensor.

The flight state of the unmanned aerial vehicle 100 is defined as rotational states and translational states.

The rotational states mean “yaw”, “pitch”, and “roll.” The translational states mean longitude, latitude, altitude, and velocity.

In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (Ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (Φ).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing unit 130 of the present invention includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement unit (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPS s.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (Φgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (Φacc)” and “pitch (θacc).” The values are used to remove a bias error included in “roll (Φgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a drone communication unit 175 for transmitting/receiving information to/from a different external device. The communication module 170 may include an input unit 171 for inputting information. The communication module 170 may include an output unit 173 for outputting information.

The output unit 173 may be omitted from the unmanned aerial vehicle 100, and may be formed in a terminal 300.

For example, the unmanned aerial vehicle 100 may directly receive information from the input unit 171. For another example, the unmanned aerial vehicle 100 may receive information, input to a separate terminal 300 or server 200, through the drone communication unit 175.

For example, the unmanned aerial vehicle 100 may directly output information to the output unit 173. For another example, the unmanned aerial vehicle 100 may transmit information to a separate terminal 300 through the drone communication unit 175 so that the terminal 300 outputs the information.

The drone communication unit 175 may be provided to communicate with an external server 200, an external terminal 300, etc. The drone communication unit 175 may receive information input from the terminal 300, such as a smartphone or a computer. The drone communication unit 175 may transmit information to be transmitted to the terminal 300. The terminal 300 may output information received from the drone communication unit 175.

The drone communication unit 175 may receive various command signals from the terminal 300 or/and the server 200. The drone communication unit 175 may receive area information for driving, a driving route, or a driving command from the terminal 300 or/and the server 200. In this case, the area information may include information on a flight restricted area (A) and information on an access limit distance.

The input unit 171 may receive On/Off or various commands. The input unit 171 may receive area information. The input unit 171 may receive object information. The input unit 171 may include various buttons or a touch pad or a microphone.

The output unit 173 may notify a user of various pieces of information. The output unit 173 may include a speaker and/or a display. The output unit 173 may output information on a discovery detected while driving. The output unit 173 may output identification information of a discovery. The output unit 173 may output location information of a discovery.

The unmanned aerial vehicle 100 includes a controller 140 for processing and determining various pieces of information, such as mapping and/or a current location. The controller 140 may control an overall operation of the unmanned aerial vehicle 100 through control of various elements that configure the unmanned aerial vehicle 100.

The controller 140 may receive information from the communication module 170 and process the information. The controller 140 may receive information from the input unit 171, and may process the information. The controller 140 may receive information from the drone communication unit 175, and may process the information.

The controller 140 may receive sensing information from the sensing unit 130, and may process the sensing information.

The controller 140 may control the driving of the motor 12. The controller 140 may control the operation of the task unit 40.

The unmanned aerial vehicle 100 includes a storage unit 150 for storing various data. The storage unit 150 records various pieces of information necessary for control of the unmanned aerial vehicle 100, and may include a volatile or non-volatile recording medium.

A map for a driving area may be stored in the storage unit 150. The map may have been input by the external terminal 300 capable of exchanging information with the unmanned aerial vehicle 100 through the drone communication unit 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

[symbol]

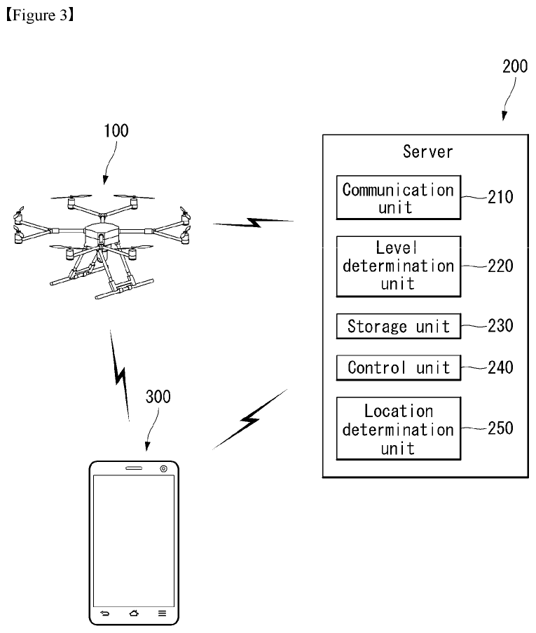

Referring to FIG. 3, the aerial control system according to an embodiment of the present invention may include the unmanned aerial vehicle 100 and the server 200, or may include the unmanned aerial vehicle 100, the terminal 300, and the server 200. The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

UE and 5G Network Block Diagram Example

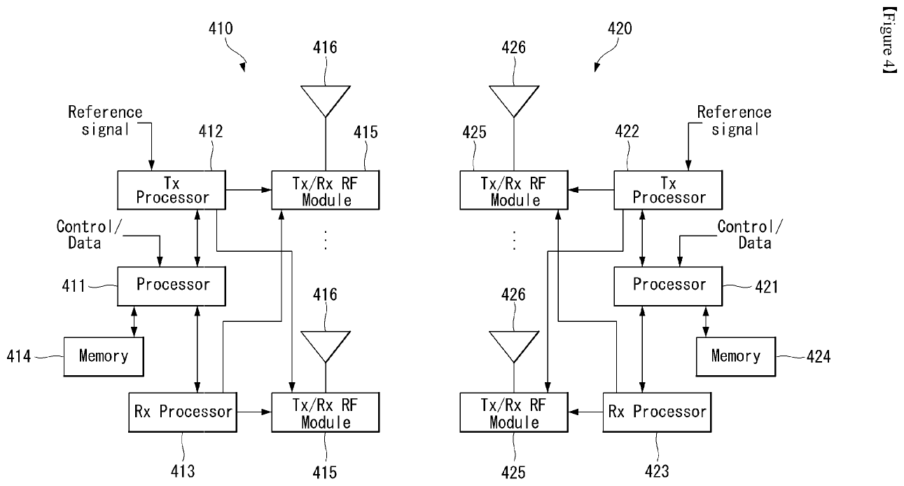

FIG. 4 illustrates a block diagram of a wireless communication system to which methods proposed in this specification may be applied.

Referring to FIG. 4, a drone is defined as a first communication device (410 of FIG. 4). A processor 411 may perform a detailed operation of the drone.

The drone may be represented as an unmanned aerial vehicle or an unmanned aerial robot.

A 5G network communicating with a drone may be defined as a second communication device (420 of FIG. 4). A processor 421 may perform a detailed operation of the drone. In this case, the 5G network may include another drone communicating with the drone.

A 5G network maybe represented as a first communication device, and a drone may be represented as a second communication device.

For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 410, the second communication device 420 includes a processor 411, 421, a memory 414, 424, one or more Tx/Rx radio frequency (RF) modules 415, 425, a Tx processor 412, 422, an Rx processor 413, 423, and an antenna 416, 426. The Tx/Rx module is also called a transceiver. Each Tx/Rx module 415 transmits a signal each antenna 426. The processor implements the above-described function, process and/or method. The processor 421 may be related to the memory 424 for storing a program code and data. The memory may be referred to as a computer-readable recording medium. More specifically, in the DL (communication from the first communication device to the second communication device), the transmission (TX) processor 412 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 410 using a method similar to that described in relation to a receiver function in the second communication device 420. Each Tx/Rx module 425 receives a signal through each antenna 426. Each Tx/Rx module provides an RF carrier and information to the RX processor 423. The processor 421 may be related to the memory 424 for storing a program code and data. The memory may be referred to as a computer-readable recording medium.

Signal Transmission/Reception Method in Wireless Communication System

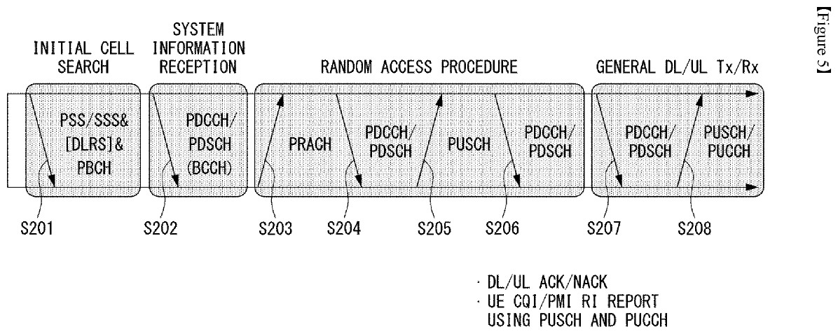

FIG. 5 is a diagram showing an example of a signal transmission/reception method in a wireless communication system.

Referring to FIG. 5, when power of a UE is newly turned on or the UE newly enters a cell, the UE performs an initial cell search task, such as performing synchronization with a BS (S501). To this end, the UE may receive a primary synchronization channel (P-SCH) and a secondary synchronization channel (S-SCH) from the BS, may perform synchronization with the BS, and may obtain information, such as a cell ID. In the LTE system and NR system, the P-SCH and the S-SCH are called a primary synchronization signal (PSS) and a secondary synchronization signal (SSS), respectively. After the initial cell search, the UE may obtain broadcast information within the cell by receiving a physical broadcast channel PBCH) form the BS. Meanwhile, the UE may identify a DL channel state by receiving a downlink reference signal (DL RS) in the initial cell search step. After the initial cell search is terminated, the UE may obtain more detailed system information by receiving a physical downlink control channel (PDCCH) and a physical downlink shared channel (PDSCH) based on information carried on the PDCCH (S502).

Meanwhile, if the UE first accesses the BS or does not have a radio resource for signal transmission, the UE may perform a random access procedure (RACH) on the BS (steps S503 to step S506). To this end, the UE may transmit a specific sequence as a preamble through a physical random access channel (PRACH) (S503 and S505), and may receive a random access response (RAR) message for the preamble through a PDSCH corresponding to a PDCCH (S504 and S506). In the case of a contention-based RACH, a contention resolution procedure may be additionally performed.

The UE that has performed the procedure may perform PDCCH/PDSCH reception (S507) and physical uplink shared channel (PUSCH)/physical uplink control channel (PUCCH) transmission (S508) as common uplink/downlink signal transmission processes. In particular, the UE receives downlink control information (DCI) through the PDCCH. The UE monitors a set of PDCCH candidates in monitoring occasions configured in one or more control element sets (CORESETs) on a serving cell based on corresponding search space configurations. A set of PDCCH candidates to be monitored by the UE is defined in the plane of search space sets. The search space set may be a common search space set or a UE-specific search space set. The CORESET is configured with a set of (physical) resource blocks having time duration of 1-3 OFDM symbols. A network may be configured so that the UE has a plurality of CORESETs.

The UE monitors PDCCH candidates within one or more search space sets. In this case, the monitoring means that the UE attempts decoding on a PDCCH candidate(s) within the search space. If the UE is successful in the decoding of one of the PDCCH candidates within the search space, the UE determines that it has detected a PDCCH in a corresponding PDCCH candidate, and performs PDSCH reception or PUSCH transmission based on DCI within the detected PDCCH. The PDCCH may be used to schedule DL transmissions on the PDSCH and UL transmissions on the PUSCH. In this case, the DCI on the PDCCH includes downlink assignment (i.e., downlink (DL) grant) related to a downlink shared channel and at least including a modulation and coding format and resource allocation information, or an uplink (DL) grant related to an uplink shared channel and including a modulation and coding format and resource allocation information.

[symbol]

An initial access (IA) procedure in a 5G communication system is additionally described with reference to FIG. 5.

A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described.

SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5.

A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

Beam Management (BM) Procedure of 5G Communication System

A BM process may be divided into (1) a DL BM process using an SSB or CSI-RS and (2) an UL BM process using a sounding reference signal (SRS). Furthermore, each BM process may include Tx beam sweeping for determining a Tx beam and Rx beam sweeping for determining an Rx beam.

A DL BM process using an SSB is described.

The configuration of beam reporting using an SSB is performed when a channel state information (CSI)/beam configuration is performed in RRC_CONNECTED.
A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.
The UE receives signals on the SSB resources from the BS based on the CSI-SSB-ResourceSetList.
If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

[symbol]

Next, a DL BM process using a CSI-RS is described.

An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described.
The UE receives an NZP CSI-RS resource set IE, including an RRC parameter regarding “repetition”, from a BS through RRC signaling. In this case, the RRC parameter “repetition” has been set as “ON.”
The UE repeatedly receives signals on a resource(s) within a CSI-RS resource set in which the RRC parameter “repetition” has been set as “ON” in different OFDM symbols through the same Tx beam (or DL spatial domain transmission filter) of the BS.
The UE determines its own Rx beam.
The UE omits CSI reporting. That is, if the RRC parameter “repetition” has been set as “ON”, the UE may omit CSI reporting.

Next, the Tx beam determination process of a BS is described.
A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.
The UE receives signals on resources within a CSI-RS resource set in which the RRC parameter “repetition” has been set as “OFF” through different Tx beams (DL spatial domain transmission filter) of the BS.
The UE selects (or determines) the best beam.
The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

[symbol]

Next, an UL BM process using an SRS is described.
A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.
The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.
If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

[symbol]

Next, a beam failure recovery (BFR) process is described.

In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

[symbol]

Ultra-Reliable and Low Latency Communication (URLLC)

URLLC transmission defined in NR may mean transmission for (1) a relatively low traffic size, (2) a relatively low arrival rate, (3) extremely low latency requirement (e.g., 0.5, lms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. eMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by positionInDCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE.

When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

[symbol]

massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH.

That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

[symbol]

Robot Basic Operation Using 5G Communication

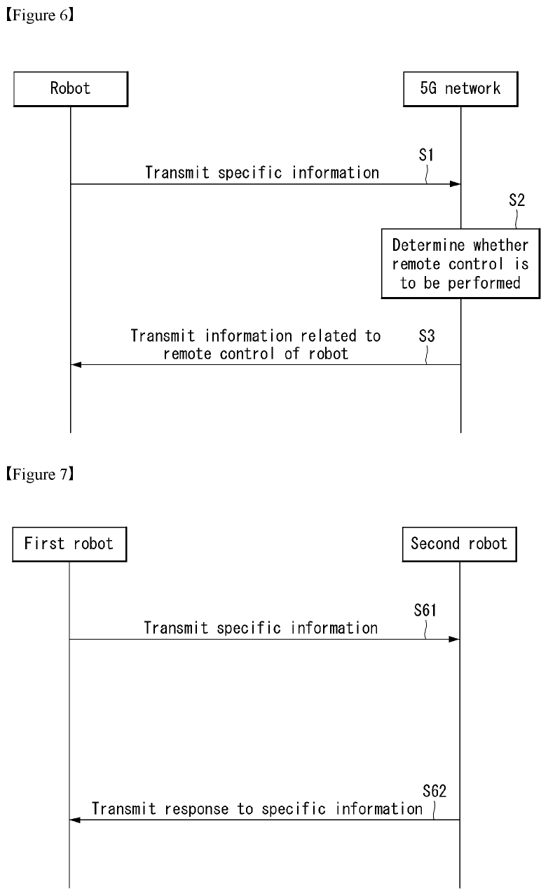

FIG. 6 shows an example of a basic operation of the robot and a 5G network in a 5G communication system.

A robot transmits specific information transmission to a 5G network (S1). Furthermore, the 5G network may determine whether the robot is remotely controlled (S2). In this case, the 5G network may include a server or module for performing robot-related remote control.

Furthermore, the 5G network may transmit, to the robot, information (or signal) related to the remote control of the robot (S3).

Application operation between robot and 5G network in 5G communication system

Hereafter, a robot operation using 5G communication is described more specifically with reference to FIGS. 1 to 6 and the above-described wireless communication technology (BM procedure, URLLC, mMTC).

First, a basic procedure of a method to be proposed later in the present invention and an application operation to which the eMBB technology of 5G communication is applied is described.

As in steps S1 and S3 of FIG. 3, in order for a robot to transmit/receive a signal, information, etc. to/from a 5G network, the robot performs an initial access procedure and a random access procedure along with a 5G network prior to step S1 of FIG. 3.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

[symbol]

A basic procedure of a method to be proposed later in the present invention and an application operation to which the URLLC technology of 5G communication is applied is described below.

As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

[symbol]

A basic procedure of a method to be proposed later in the present invention and an application operation to which the mMTC technology of 5G communication is applied is described below.

A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

[symbol]

Operation Between Robots Using 5G Communication

FIG. 7 illustrates an example of a basic operation between robots using 5G communication.

A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

[symbol]

An application operation between robots using 5G communication is described below.

First, a method for a 5G network to be directly involved in the resource allocation of signal transmission/reception between robots is described.

The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below.

A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in the present inventions, and may be applied or may be supplemented to materialize or clarify the technical characteristics of methods proposed in the present inventions.

[symbol]

Drone

Unmanned aerial system: a combination of a UAV and a UAV controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

[symbol]

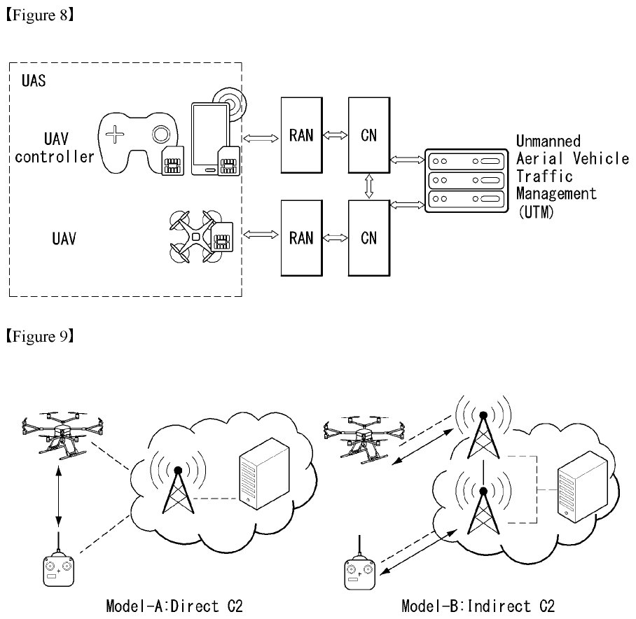

FIG. 8 is a diagram showing an example of the concept diagram of a 3GPP system including a UAS.

An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows.
A 3GPP system enables the UAS to transmit different UAS data to UTM based on different certification and an authority level applied to the UAS.
A 3GPP system supports a function of expanding UAS data transmitted to UTM along with future UTM and the evolution of a support application.
A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.
A 3GPP system enables the UE of a UAS to transmit an identity, such as an IMEI, MSISDN or IMSI or IP address, to UTM.
A 3GPP system enables a mobile network operator (MNO) to supplement data transmitted to UTM, along with network-based location information of a UAV and a UAV controller.
A 3GPP system enables MNO to be notified of a result of permission so that UTM operates.
A 3GPP system enables MNO to permit a UAS certification request only when proper subscription information is present.
A 3GPP system provides the ID(s) of a UAS to UTM.
A 3GPP system enables a UAS to update UTM with live location information of a UAV and a UAV controller.
A 3GPP system provides UTM with supplement location information of a UAV and a UAV controller.
A 3GPP system supports UAVs, and corresponding UAV controllers are connected to other PLMNs at the same time.
A 3GPP system provides a function for enabling the corresponding system to obtain UAS information on the support of a 3GPP communication capability designed for a UAS operation.
A 3GPP system supports UAS identification and subscription data capable of distinguishing between a UAS having a UAS capable UE and a USA having a non-UAS capable UE.
A 3GPP system supports detection, identification, and the reporting of a problematic UAV(s) and UAV controller to UTM.

In the service requirement of Rel-16 ID UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

FIG. 9 shows examples of a C2 communication model for a UAV.

Model—A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model—B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV traffic management

(1) Centralized UAV traffic management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-centralized UAV traffic management
A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.
A 3GPP system supports a UAV in order to transmit a message through a network connection for identification between different UAVs. The UAV preserves owner's personal information of a UAV, UAV pilot and UAV operator in the broadcasting of identity information.
A 3GPP system enables a UAV to receive local broadcasting communication transmission service from another UAV in a short distance.
A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.
A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.
A 3GPP system supports the direct UAV versus UAV local broadcast communication transmission service capable of guaranteeing separation between UAVs. In this case, the UAVs may be considered to have been separated if they are in a horizontal distance of at least 50m or a vertical distance of 30m or both. The 3GPP system supports the direct UAV versus UAV local broadcast communication transmission service that supports the range of a maximum of 600m.
A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms.
A UAV may broadcast its own identity locally at least once per second, and may locally broadcast its own identity up to a 500m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP support for aerial UE (or drone) communication

An E-UTRAN-based mechanism that provides an LTE connection to a UE capable of aerial communication is supported through the following functions.
Subscription-based aerial UE identification and authorization defined in Section TS 23.401, 4.3.31.
Height reporting based on an event in which the altitude of a UE exceeds a reference altitude threshold configured with a network.
Interference detection based on measurement reporting triggered when the number of configured cells (i.e., greater than 1) satisfies a triggering criterion at the same time.
Signaling of flight route information from a UE to an E-UTRAN.
Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference detection and mitigation for aerial UE communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting.

Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents.
UE-specific partial pathloss compensation factor
UE-specific Po parameter
Neighbor cell interference control parameter
Closed-loop power control

The power control-based mechanism for UL interference mitigation is described more specifically.

1) UE-Specific Partial Pathloss Compensation Factor

The enhancement of the existing open-loop power control mechanism is taken into consideration in the place where a UE-specific partial pathloss compensation factor α_{UE} is introduced. Due to the introduction of the UE-specific partial pathloss compensation factor α_{UE} different α_{UE} may be configured by comparing an aerial UE with a partial pathloss compensation factor configured in a terrestrial UE.

2) UE-Specific P0 Parameter

Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor α_{UE} and the UE-specific Po may be used in common for uplink interference mitigation. Accordingly, the UE-specific partial pathloss compensation factor α_{UE} and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

[symbol]

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.
Improvement of a handover procedure for an aerial UE and/or mobility of a handover-related parameter based on location information and information, such as the aerial state of a UE and a flight route plan
A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

A measurement execution method which may be applied to an aerial UE is described more specifically.

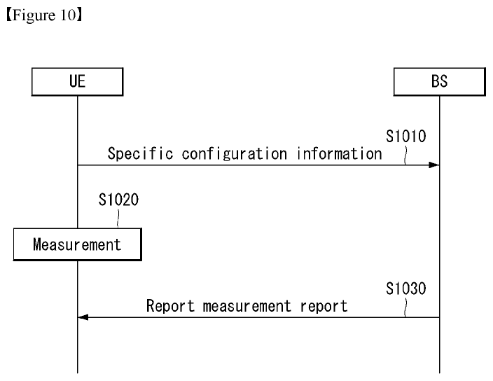

FIG. 10 is a flowchart showing an example of a measurement execution method to which the present invention may be applied.

An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2.

Event H1 (aerial UE height exceeding a threshold)

A UE considers that an entering condition for the event is satisfied when 1) the following defined condition H1-1 is satisfied, and considers that a leaving condition for the event is satisfied when 2) the following defined condition H1-2 is satisfied.

Ms−Hys>Thresh+Offset Inequality H1-1 (Entering condition):

Ms+Hys<Thresh+Offset Inequality H1-2 (leaving condition):

In the above equation, the variables are defined as follows.

Ms is an aerial UE height and does not take any offset into consideration. Hys is a hysteresis parameter (i.e., hl-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Ms+Hys<Thresh+Offset Inequality H2-1 (entering condition):

Ms−Hys>Thresh+Offset Inequality H2-2 (leaving condition):

In the above equation, the variables are defined as follows.

Ms is an aerial UE height and does not take any offset into consideration. Hys is a hysteresis parameter (i.e., hl-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: information for configuring a filtering of measurement unit, reporting unit and/or measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1
--ASN1START..... MeasParameters-v1530 ::= SEQUENCE {qoe-MeasReport-r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidity Area-r15
ENUMERATED {supported} OPTIONAL, heightMeas-r15 ENUMERATED {supported}

| | |
|---|---|
| OPTIONAL, multipleCellsMeasExtension-r15 | ENUMERATED {supported} |

OPTIONAL} .....

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

[symbol]

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling.

In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling.

In the case of X2-based handover, aerial UE subscription information of a user is transmitted to a target BS as follows:
If a source BS supports the aerial UE function and aerial UE subscription information of a user is included in UE context, the source BS includes corresponding information in the X2-AP handover request message of a target BS.
An MME transmits, to the target BS, the aerial UE subscription information in a Path Switch Request Acknowledge message.

An object of a handover resource allocation procedure is to secure, by a target BS, a resource for the handover of a UE.

If aerial UE subscription information is changed, updated aerial UE subscription information is included in an S1-AP UE context modification request message transmitted to a BS.

Table 2 is a table showing an example of the aerial UE subscription information.

TABLE 2

| IE/Group Name | Presence | Range | IE type and reference |
|---|---|---|---|
| Aerial UE subscrip- | M | | ENUMERATED |
| tion information | | | (allowed, not allowed, . . .) |

Aerial UE subscription information is used by a BS in order to know whether a UE can use the aerial UE function.

[symbol]

Combination of Drone and eMBB

A 3GPP system can support data transmission for a UAV (aerial UE or drone) and for an eMBB user at the same time.

A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

[symbol]

The terminal 300 may include a controller receiving a control command controlling the unmanned aerial vehicle 100 and an output unit outputting visual or audio information.

The server 200 stores information on the flight restricted area (A) in which a flight of the unmanned aerial vehicle 100 is restricted, differently calculates an access limit distance of the flight restricted area (A) depending on an autonomous flying level of the unmanned aerial vehicle 100, and provides information on the flight restricted area (A) and information on the access limit distance to at least one of the unmanned aerial vehicle 100 and the terminal 300. Thus, the server 200 enables the unmanned aerial vehicle 100 with a high autonomous flying level to fly along an effective path and can prevent an accident that may occur when the unmanned aerial vehicle 100 with a low autonomous flying level approaches the flight restricted area (A).

The server 200 may set a flight path based on information on the flight restricted area (A) and information on the access limit distance and provide the flight path to at least one of the unmanned aerial vehicle 100 and the terminal 300.

Actively, the server 200 may set the flight path based on information on the flight restricted area (A) and information on the access limit distance depending on the autonomous flying level and control the unmanned aerial vehicle 100 along the flight path.

The server 200 may send different commands to the unmanned aerial vehicle 100 depending on the autonomous flying level if the unmanned aerial vehicle 100 approaches within the access limit distance. The server 200 may send different commands to the unmanned aerial vehicle 100 depending on whether the unmanned aerial vehicle 100 is automatically or manually adjusted.

[symbol]

For example, the server 200 may include a communication unit that exchanges information with the unmanned aerial vehicle 100 and/or the terminal 300, a level determination unit 220 that determines the autonomous flying level of the unmanned aerial vehicle 100, a storing unit 230 that stores information on the flight restricted area (A) in which the flight of the unmanned aerial vehicle 100 is restricted, and a control unit 240 that provides information to the unmanned aerial vehicle 100 and/or the terminal 300 or controls the unmanned aerial vehicle 100 and/or the terminal 300. The server 200 may further include a location determination unit 250 that determines a location and an altitude of the unmanned aerial vehicle 100 through location altitude information provided by the unmanned aerial vehicle 100.

The storing unit 230 may store information on the flight restricted area (A), information on the autonomous flying level of the unmanned aerial vehicle 100, and information on aerial control of the unmanned aerial vehicle 100, for the aerial control.

[symbol]

The level determination unit 220 determines the autonomous flying level of the unmanned aerial vehicle 100. The level determination unit 220 determines the autonomous flying level of the unmanned aerial vehicle 100 through information on the autonomous flying level transmitted from the unmanned aerial vehicle 100 to the server 200 or information on the autonomous flying level provided by the terminal 300.

The autonomous flying level of the unmanned aerial vehicle 100 may include level 1 at which only a completely manual flying is allowed or the manual flying is assisted by various sensors, level 2 at which the unmanned aerial vehicle 100 performs a semi-autonomous flying (automatic takeoff and landing, passive obstacle avoidance, movement along a path designated by a user), and level 3 at which the unmanned aerial vehicle 100 performs a completely autonomous flying (that creates a path by itself, moves to a destination S2, and performs an operation by itself).

The control unit 240 differently calculates an access limit distance of the flight restricted area (A) depending on the autonomous flying level of the unmanned aerial vehicle 100 and provides information on the flight restricted area (A) and information on the access limit distance to the unmanned aerial vehicle 100 and/or the terminal 300.

The information on the flight restricted area (A) may include location information of the flight restricted area (A) and boundary information of the flight restricted area (A).

Here, providing information of the control unit 240 to the unmanned aerial vehicle 100 and/or the terminal 300 means that transmission of information data to the unmanned aerial vehicle 100 and/or the terminal 300 through a wireless communication method such as 5G.

[symbol]

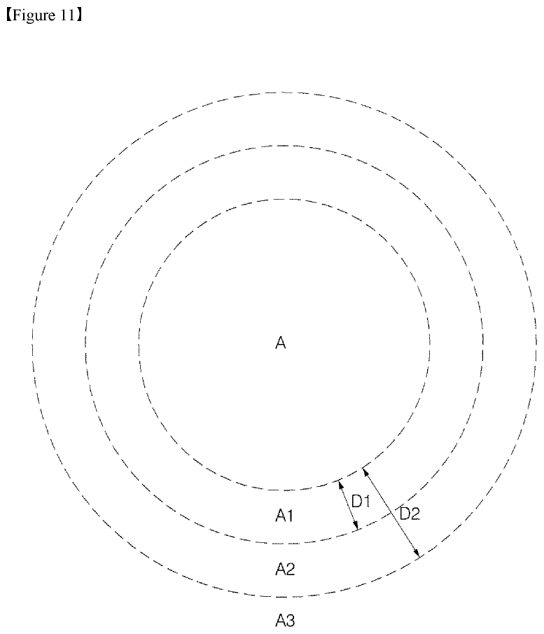

In particular, referring to FIG. 11, the access limit distance may be defined as a distance spaced apart from a boundary of the flight restricted area (A) to the outside. The control unit 240 sets the access limit distance to decrease as the autonomous flying level increases. The control unit 240 may differently set the access limit distance depending on a type or location of the flight restricted area (A). If the flight restricted area (A) is a type to prevent a human life accident, the control unit 240 may set the access limit distance to relatively increase. If the flight restricted area (A) is a type that has nothing to do with a human life accident, the control unit 240 may set the access limit distance to relatively decrease.

Specifically, if the autonomous flying level is the level 3, a flight limit distance may be set to a first distance; if the autonomous flying level is the level 2, the flight limit distance may be set to a second distance D1 greater than the first distance; and if the autonomous flying level is the level 1, the flight limit distance may be set to a third distance D2 greater than the first distance and the second distance D1. More specifically, if the autonomous flying level is the level 3, the first distance may be set to zero.

Preferably, the control unit 240 may provide a flying path to the unmanned aerial vehicle 100 or control the unmanned aerial vehicle 100 so that the unmanned aerial vehicle 100 with the autonomous flying level of the level 3 flies in a first area A1 between a boundary, which is spaced apart from the boundary of the flight restricted area (A) by the second distance D1, and the boundary of the flight restricted area (A). The control unit 240 may provide a flying path to the unmanned aerial vehicle 100 or control the unmanned aerial vehicle 100 so that the unmanned aerial vehicle 100 with the autonomous flying level of the level 2 flies in a second area A2 between a boundary, which is spaced apart from the boundary of the flight restricted area (A) by the third distance D2, and a boundary, which is spaced apart from the boundary of the flight restricted area (A) by the second distance D1.

The control unit 240 may provide a flying path to the unmanned aerial vehicle 100 so that the unmanned aerial vehicle 100 with the autonomous flying level of the level 1 flies in a third area A3 outside a boundary, which is spaced apart from the boundary of the flight restricted area (A) by the second distance D1.

Thus, because the unmanned aerial vehicle 100 flies in differently separated areas around the flight restricted area (A) depending on the autonomous flying level, the present invention can prevent a collision accident that may occur by the unmanned aerial vehicle 100 with the low autonomous flying level.

[symbol]

If the unmanned aerial vehicle 100 approaches within the access limit distance, the control unit 240 may send a different command to the unmanned aerial vehicle 100 depending on the autonomous flying level. Thus, the control unit 240 can induce the efficient flying in the flight restricted area (A) depending on the autonomous flying level and prevent the accident.

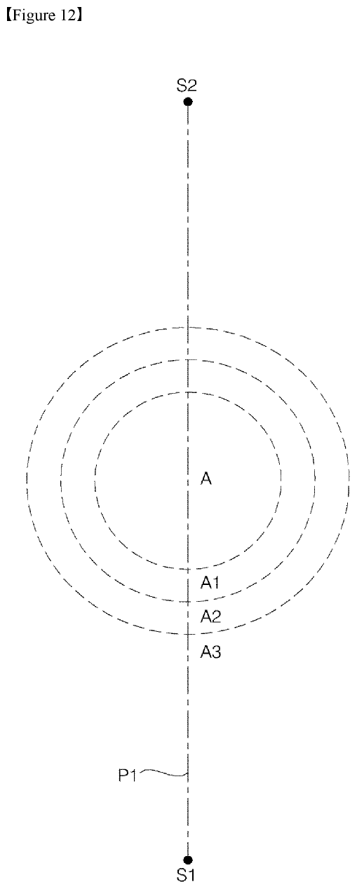

More specifically, referring to FIG. 12, if the user inputs a destination S2 to the unmanned aerial vehicle 100 at a departure location S1, the unmanned aerial vehicle 100 with the autonomous flying level equal to or greater than the level 2 sets a shortest flying path P1 by itself. However, the shortest flying path may include a path passing the flight restricted area (A).

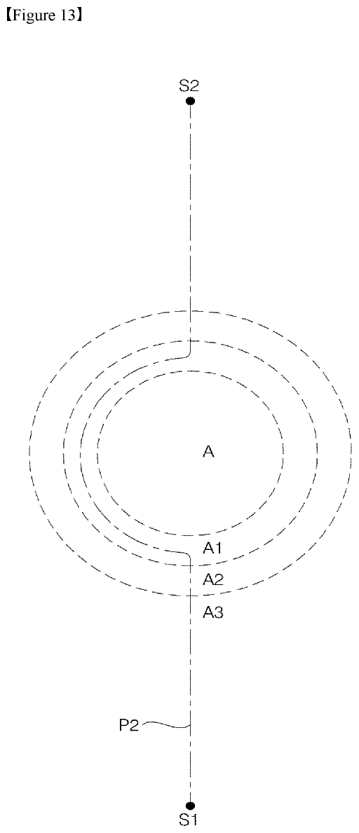

Referring to FIG. 13, if the flight restricted area (A) is included in a flying path set by the unmanned aerial vehicle 100, the server 200 may set an avoidance path P2 avoiding the vicinity of the flight restricted area (A) and provide the avoidance path P2 to the unmanned aerial vehicle 100 or control the unmanned aerial vehicle 100 along the avoidance path P2. In the case of the unmanned aerial vehicle 100 with the autonomous flying level of the level 3, the server 200 may set a path avoiding the flight restricted area (A) through the first area A1.

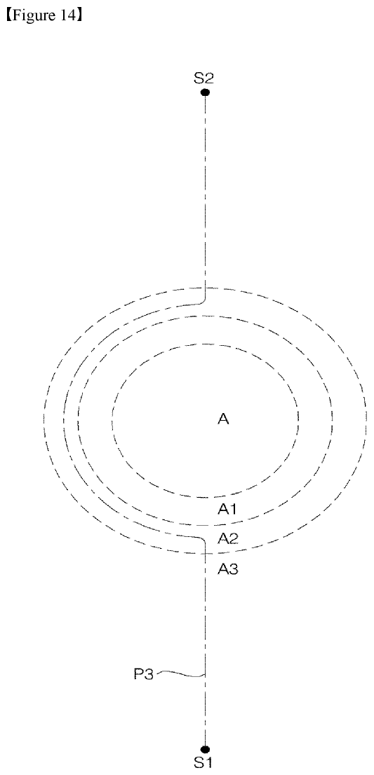

Referring to FIG. 14, in the case of the unmanned aerial vehicle 100 with the autonomous flying level of the level 2, the server 200 may set a path P3 avoiding the flight restricted area (A) through the second area A2.

If the unmanned aerial vehicle 100 approaches within the access limit distance, the server 200 may provide a new flight path to the unmanned aerial vehicle 100 depending on the autonomous flying level. Specifically, if the unmanned aerial vehicle 100 approaches within the access limit distance, the control unit 240 may send a command that allows the unmanned aerial vehicle 100 to fly along a new flight path for a destination S2 based on information on the flight restricted area (A) and information on the access limit distance, when the autonomous flying level exceeds a predetermined level. Here, the new flight path is a flight path including an avoidance path illustrated in FIGS. 5b and 5c. In this case, the control unit 240 may also provide the new flight path to the terminal 300. Here, the predetermined autonomous flying level may be the level 1.

If the unmanned aerial vehicle 100 approaches within the access limit distance, the control unit 240 may control the unmanned aerial vehicle 100 to move to a location farther than the access limit distance in the flight restricted area (A) when the autonomous flying level is equal to or less than a predetermined level or less. Here, the predetermined autonomous flying level is the level 1. Since it may be difficult to set a path of the unmanned aerial vehicle 100 when the autonomous flying level is low, the control unit 240 simply controls the unmanned aerial vehicle 100 to be out of the access limit distance.

The server 200 can control the unmanned aerial vehicle 100 and also inform the user of an access of a flight access area or a deviation path. Specifically, if the unmanned aerial vehicle 100 approaches within the access limit distance, the control unit 240 may control the terminal 300 to output an access alarm of the flight restricted area (A) when the autonomous flying level of the unmanned aerial vehicle 100 is the level 2 or less. If the unmanned aerial vehicle 100 approaches within the access limit distance, the server 200 may send, to the terminal 300, a control command that allows the terminal 300 to output the access notification of the flight restricted area (A). Here, the access notification of the flight restricted area (A) may be an image or a sound.

The server 200 can control the unmanned aerial vehicle 100 and also inform the user of a deviation path. Specifically, if the unmanned aerial vehicle 100 approaches within the access limit distance, the control unit 240 may control the terminal 300 to output a deviation path of the flight restricted area (A). A user of the unmanned aerial vehicle 100 with the low autonomous flying level (level 1) may operate the unmanned aerial vehicle 100 along the deviation path of the flight restricted area (A).

The server 200 can prevent accidents near the flight restricted area (A) considering whether or not the unmanned aerial vehicle 100 is automatically adjusted, as well as the autonomous flying level of the unmanned aerial vehicle 100.

The server 200 may determine the automatic adjustment or the manual adjustment of the unmanned aerial vehicle 100, and control the terminal 300 to output the access alarm of the flight restricted area (A) in the case of the manual adjustment regardless of the autonomous flying level if the unmanned aerial vehicle 100 approaches within the access limit distance. Specifically, the level determination unit 220 may determine the automatic adjustment or the manual adjustment of the unmanned aerial vehicle 100 using drone information provided by the unmanned aerial vehicle 100.

If the unmanned aerial vehicle 100 approaches within the access limit distance, the control unit 240 may control the terminal 300 to output the access alarm of the flight restricted area (A) in the case of the manual adjustment regardless of the autonomous flying level.

The control unit 240 may allow the unmanned aerial vehicle 100 to approach within the access limit distance depending on a level of the user in the case of the manual adjustment regardless of the autonomous flying level. Here, allowing the unmanned aerial vehicle 100 to approach within the access limit distance may mean that the terminal 300 and the unmanned aerial vehicle 100 are not informed of an alarm or a separate command even if the unmanned aerial vehicle 100 approaches within the access limit distance.

Specifically, if the manual adjustment is used regardless of the autonomous flying level, and the level of the user is higher than a predetermined level, the server 200 may allow the unmanned aerial vehicle 100 to approach within the access limit distance. In this case, it is a matter of course that the server 200 can output an alarm through the terminal 300 if the unmanned aerial vehicle 100 enters the flight restricted area (A).

If the unmanned aerial vehicle 100 approaches within the access limit distance, the control unit 240 may control the unmanned aerial vehicle 100 to be forced to land when the level of the user is equal to or less than a predetermined level in the case of the manual adjustment.

[symbol]

The present invention may be a computer program including each step of a control method, or may be a recording medium on which a program for implementing a control method by a computer is recorded. The ‘recording medium’ indicates a computer-readable recording medium. The present invention may be a control system of the unmanned aerial vehicle 100 including both hardware and software.

Each step of flow charts illustrating the control method and combinations of the flow charts may be performed by computer program instructions. The instructions may be mounted on a general purpose computer or a special purpose computer, etc., and may create means performing functions described in step(s) of the flow chart.

In some embodiments, the functions mentioned in the steps may occur out of order. For example, two successively illustrated steps may be actually performed substantially at the same time, or may be sometimes performed in reverse order depending on the functions.

[symbol]

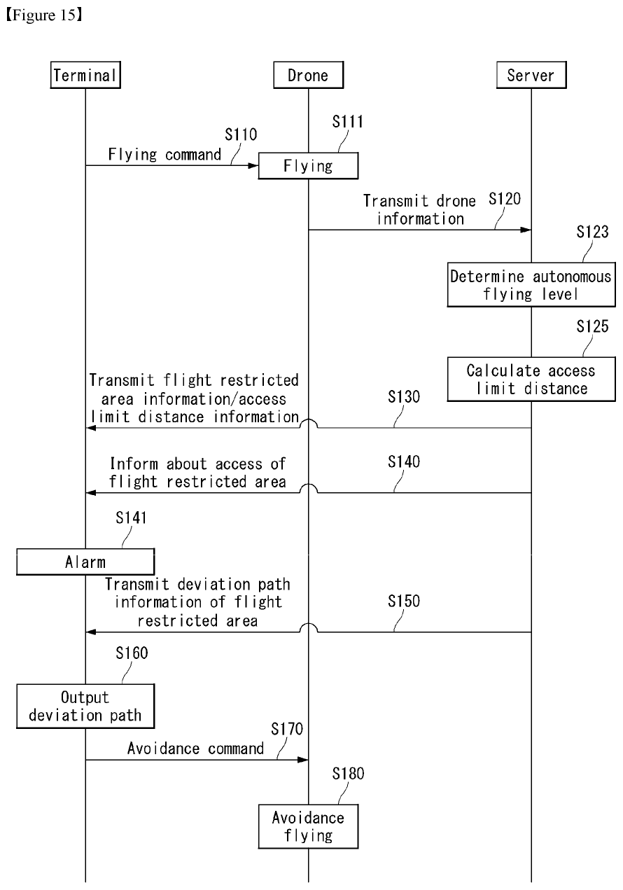

FIG. 15 is a flow chart illustrating a method of controlling an aerial control system according to a first embodiment of the present invention.

Referring to FIG. 15, a first embodiment is a case in which an autonomous flying level of an unmanned aerial vehicle 100 is level 1.

A user commands the unmanned aerial vehicle 100 to fly in S110. Specifically, a terminal 300 receives a flying command of the user, converts it into a drone control command, and sends the drone control command to the unmanned aerial vehicle 100.

The unmanned aerial vehicle 100 receiving the flying command flies according to the flying command in S110. The unmanned aerial vehicle 100 starting to fly transmits drone information to a server 200 in S120. The drone information includes an autonomous flying level of a drone, location and altitude information of the drone, identification information of the drone, control information of the drone, and the like.

The server 200 receiving the drone information stores it in a storing unit 230 and determines an autonomous flying level of the unmanned aerial vehicle 100 in S123, and calculates an access limit distance of the unmanned aerial vehicle 100 depending on the autonomous flying level in S125.

The server 200 transmit, to the unmanned aerial vehicle 100, information on a flight restricted area (A) and information on the access limit distance depending on the autonomous flying level in S130.

If the unmanned aerial vehicle 100 approaches within the access limit distance, the server 200 may send, to the terminal 300, a control command that allows the terminal 300 to output an access alarm of the flight restricted area (A) in S140.

The terminal 300 receiving the control command that allows the terminal 300 to output the access alarm of the flight restricted area (A) outputs the access alarm of the flight restricted area (A) in S141.

If the unmanned aerial vehicle 100 approaches within the access limit distance, the server 200 may transmit deviation path information of the flight restricted area (A) to the terminal 300 in S150.

The terminal 300 receiving the deviation path information of the flight restricted area (A) outputs a deviation path of the flight restricted area (A) in S160.

The user sends, to the unmanned aerial vehicle 100, an avoidance command according to the deviation path of the flight restricted area (A) in S170. The unmanned aerial vehicle 100 receiving the avoidance command flies avoiding the flight restricted area (A) in S180.

[symbol]

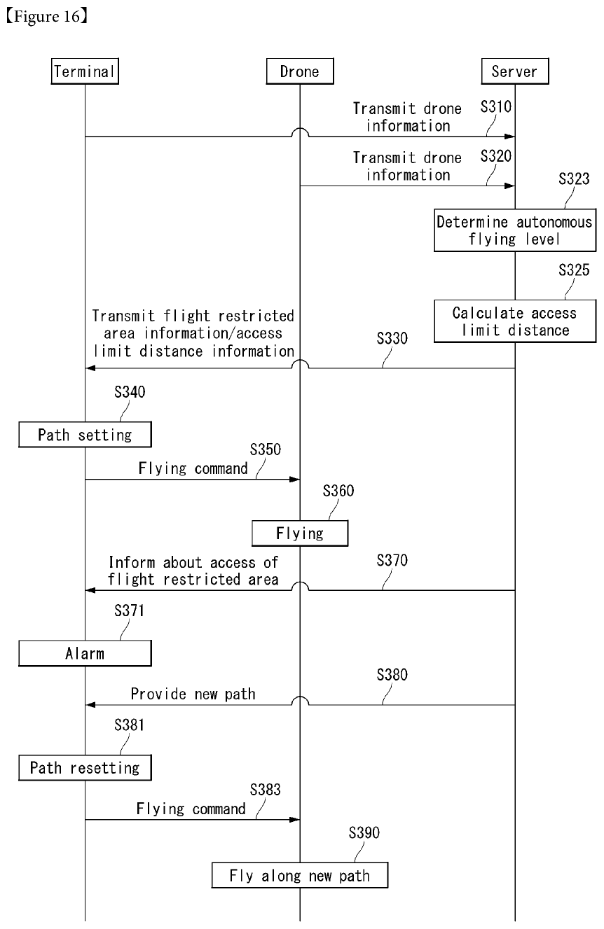

FIG. 16 is a flow chart illustrating a method of controlling an aerial control system according to a second embodiment of the present invention.

Referring to FIG. 16, a second embodiment is a case in which an autonomous flying level of an unmanned aerial vehicle 100 is level 2.

An unmanned aerial vehicle 100 and/or a terminal 300 sends drone information to a server 200 in S310. The server 200 receiving the drone information stores it in a storing unit 230 and determines an autonomous flying level of the unmanned aerial vehicle 100 in S323, and calculates an access limit distance of the unmanned aerial vehicle 100 depending on the autonomous flying level in S325.

A user sets a path based on information on a flight restricted area (A) and information on the access limit distance and inputs the path to the terminal 300 in S340. The terminal 300 sends, to the unmanned aerial vehicle 100, a flying command that allows the unmanned aerial vehicle 100 to fly along the set path in S350. The unmanned aerial vehicle 100 receiving the flying command flies along the set path in S360.

If the unmanned aerial vehicle 100 approaches within the access limit distance, the server 200 may send, to the terminal 300, a control command that allows the terminal 300 to output an access alarm of the flight restricted area (A) in S370.

The terminal 300 receiving the control command that allows the terminal 300 to output the access alarm of the flight restricted area (A) outputs the access alarm of the flight restricted area (A) in S141.

If the unmanned aerial vehicle 100 approaches within the access limit distance, the server 200 transmits, to the terminal 300, a new flight path out of the access limit distance based on information on the flight restricted area (A) and information on the access limit distance in S380.

The terminal 300 receiving the new flight path outputs the new flight path, and the user resets a flight path along the new flight path and sends a flying command according to a new path to the unmanned aerial vehicle 100 in S383. The unmanned aerial vehicle 100 receiving the flying command flies along the new path in S390.

[symbol]

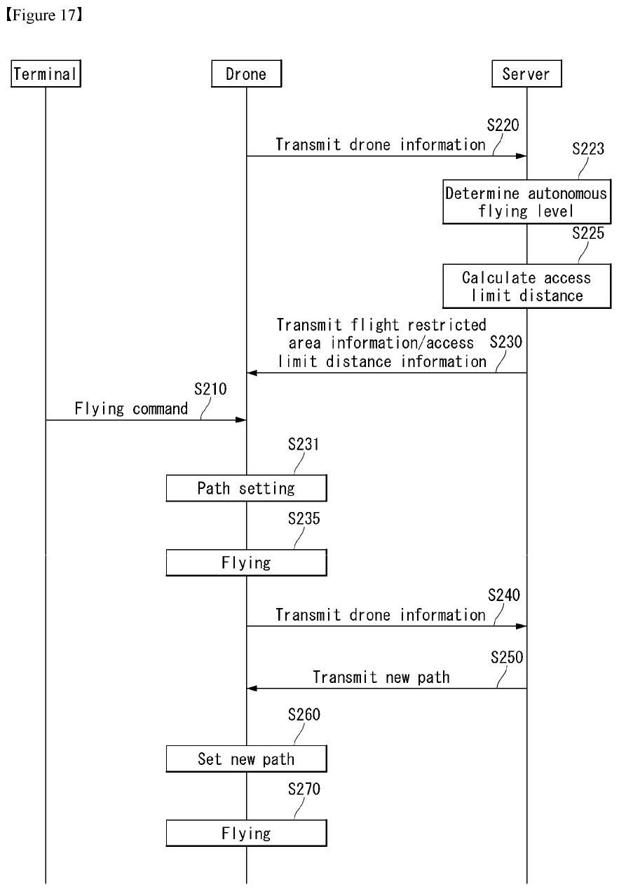

FIG. 17 is a flow chart illustrating a method of controlling an aerial control system according to a third embodiment of the present invention.

Referring to FIG. 17, a third embodiment is a case in which an autonomous flying level of an unmanned aerial vehicle 100 is level 3.

A user commands the unmanned aerial vehicle 100 to fly in S210. Specifically, a terminal 300 receives a flying command (including destination (S2) information) of the user, converts it into a drone control command, and sends the drone control command to the unmanned aerial vehicle 100.

The unmanned aerial vehicle 100 receiving the flying command transmits drone information to a server 200 in S220. The drone information includes an autonomous flying level of a drone, location and altitude information of the drone, identification information of the drone, control information of the drone, and the like.

The server 200 receiving the drone information stores it in a storing unit 230 and determines an autonomous flying level of the unmanned aerial vehicle 100 in S223, and calculates an access limit distance of the unmanned aerial vehicle 100 depending on the autonomous flying level in S225.

The unmanned aerial vehicle 100 sets a path based on information on a flight restricted area (A) and information on the access limit distance in S231, and flies along the set path in S235.

The unmanned aerial vehicle 100 starting to fly continues to transmit drone information including real-time location information of the unmanned aerial vehicle 100 to the serer 200 in S240.

If the unmanned aerial vehicle 100 approaches within the access limit distance, the serer 200 sends a new flight path out of the access limit distance to the unmanned aerial vehicle 100 based on information on the flight restricted area (A) and information on the access limit distance in S250.

The unmanned aerial vehicle 100 receiving the new flight path sets the new flight path in S260, and flies along the new flight path in S270.

[symbol]

Hereinafter, a control method of the aerial control system described above will be described in detail by embodiments performing methods proposed in the present specification through combinations with the 5G communication technology (e.g., eMBB), AI, etc.

The unmanned aerial vehicle, the drone, the unmanned aerial robot, etc. used in the present specification may be interpreted in the same sense.

An operation method of a base station for the control of the aerial control system proposed in the present specification is described below.

To this end, the base station may include a communication unit, a level determination unit, a storing unit, a control unit (or a processor or a controller) and the like, and the control unit may be functionally connected to the communication unit, the level determination unit, and the storing unit.

The base station may transmit and receive information with the unmanned aerial vehicle.

That is, the communication unit of the base station transmits and receives information with the unmanned aerial vehicle.

The level determination unit of the base station determines an autonomous flying level of the unmanned aerial vehicle.

The storing unit of the base station stores information on a flight restricted area in which a flight of the unmanned aerial vehicle is restricted.

The control unit of the base station differently calculates an access limit distance of the flight restricted area depending on the autonomous flying level of the unmanned aerial vehicle and provides the unmanned aerial vehicle with information on the flight restricted area and information on the access limit distance.

[symbol]

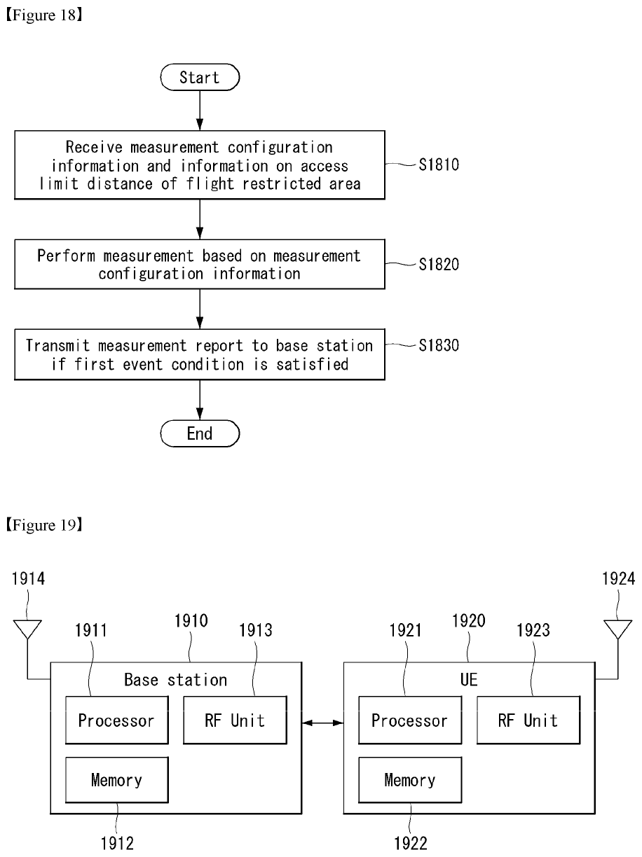

FIG. 18 is a flow chart illustrating an example of an operation method of an unmanned aerial vehicle for control of an aerial control system proposed by the present specification.

An unmanned aerial vehicle may include a communication unit and a processor (or a control unit or a controller) and the like, and the processor may be functionally connected to the communication unit.

First, the unmanned aerial vehicle receives, from a base station, measurement configuration information and information on an access limit distance of a flight restricted area in S1810. The step S1810 is performed by the communication unit of the unmanned aerial vehicle.

The unmanned aerial vehicle performs a measurement based on the measurement configuration information in S1820. The step S1820 is performed by the processor of the unmanned aerial vehicle.

The unmanned aerial vehicle transmits a measurement report to the base station if a first event condition included in the measurement configuration information is satisfied, in S1830. The step S1830 is performed by the communication unit of the unmanned aerial vehicle.

Here, if a distance related to the first event condition corresponds to the access limit distance of the flight restricted area, the measurement report may include information informing that the unmanned aerial vehicle is located in the flight restricted area.

The access limit distance of the flight restricted area may be determined depending on an autonomous flying level.

The first event condition may be Ms+Hys<Thresh+Offset

The measurement report may further include at least one of location altitude information or flight path information.

In addition, the processor of the unmanned aerial vehicle may control the communication unit to receive downlink control information (DCI) used to schedule a transmission of the measurement report from the base station.

In this case, the measurement report may be transmitted to the base station based on the DCI.

The processor of the unmanned aerial vehicle may be configured to perform an initial connection procedure with the base station based on a synchronization signal block (SSB).

In this case, the measurement report may be transmitted via a PUSCH, and the SSB and a DM-RS of the PUSCH may be quasi co-located (QCL) with respect to QCL type D.

The unmanned aerial vehicle may further include a photographing unit collecting real-time information. In this case, the processor of the unmanned aerial vehicle may control the communication unit to transmit the real-time information to an AI system and control the communication unit to receive processed information from the AI system.

Here, the real-time information may include at least one of high precision three dimensional surface topography data, a real-time photo, or a real-time video.

[symbol]

Overview of device to which the present invention is applicable

FIG. 19 illustrates a block configuration diagram of a wireless communication device according to an embodiment of the present invention.

Referring to FIG. 19, a wireless communication system includes a base station (or network) 1910 and a terminal 1920.

Here, examples of the terminal may include a user equipment (UE), a unmanned aerial vehicle (UAV), a drone, a wireless aerial robot, and the like.

The base station 1910 includes a processor 1911, a memory 1912, and a communication module 1913.

The processor 1911 implements functions, processes, and/or methods proposed in FIGS. 1 to 18. Layers of wired/wireless interface protocol may be implemented by the processor 1911. The memory 1912 is connected to the processor 1911 and stores various types of information for driving the processor 1911. The communication module 1913 is connected to the processor 1911 and transmits and/or receives wired/wireless signals.

The communication module 1913 may include a radio frequency (RF) unit for transmitting/receiving a radio signal.

The UE 1920 includes a processor 1921, a memory 1922, and a communication module (or RF unit) 1923. The processor 1921 implements functions, processes, and/or methods proposed in FIGS. 1 to 18. Layers of a radio interface protocol may be implemented by the processor 1921. The memory 1922 is connected to the processor 1921 and stores various types of information for driving the processor 1921. The communication module 1923 is connected to the processor 1921 and transmits and/or receives a radio signal.

The memories 1912 and 1922 may be inside or outside the processors 1911 and 1921 and may be connected to the processors 1911 and 1921 through various well-known means.

Further, the base station 1910 and/or the UE 1920 may have a single antenna or multiple antennas.

[symbol]

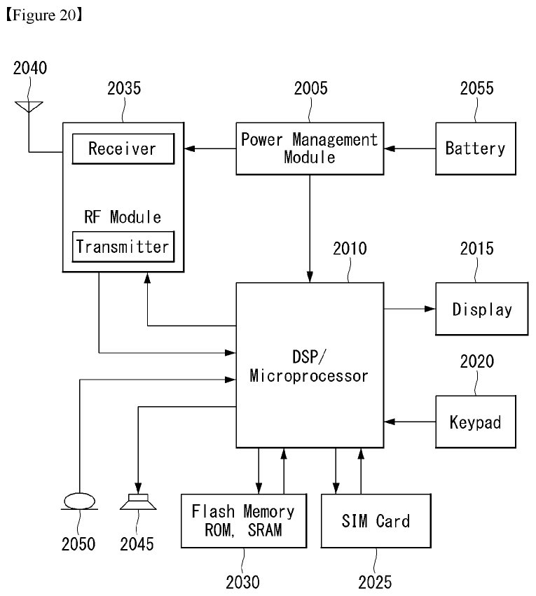

FIG. 20 illustrates a block configuration diagram of a communication device according to an embodiment of the present invention.

In particular, FIG. 20 illustrates in more detail the UE illustrated in FIG. 19.

Referring to FIG. 20, the UE may include a processor (or digital signal processor (DSP)) 2010, an RF module (or RF unit) 2035, a power management module 2005, an antenna 2040, a battery 2055, a display 2015, a keypad 2020, a memory 2030, a subscriber identification module (SIM) card 2025 (which is optional), a speaker 2045, and a microphone 2050. The UE may also include a single antenna or multiple antennas.

The processor 2010 implements functions, processes, and/or methods proposed in FIGS. 1 to 18. Layers of a radio interface protocol may be implemented by the processor 2010.

The memory 2030 is connected to the processor 2010 and stores information related to operations of the processor 2010. The memory 2030 may be inside or outside the processor 2010 and may be connected to the processors 2010 through various well-known means.

A user inputs instructional information, such as a telephone number, for example, by pushing (or touching) buttons of the keypad 2020 or by voice activation using the microphone 2050. The processor 2010 receives and processes the instructional information to perform an appropriate function, such as to dial the telephone number. Operational data may be extracted from the SIM card 2025 or the memory 2030. Further, the processor 2010 may display instructional information or operational information on the display 2015 for the user's reference and convenience.

The RF module 2035 is connected to the processor 2010 and transmits and/or receives an RF signal. The processor 2010 forwards instructional information to the RF module 2035 in order to initiate communication, for example, transmit a radio signal configuring voice communication data. The RF module 2035 includes a receiver and a transmitter to receive and transmit the radio signal. The antenna 2040 functions to transmit and receive the radio signal. Upon reception of the radio signal, the RF module 2035 may transfer a signal to be processed by the processor 2010 and convert the signal into a baseband. The processed signal may be converted into audible or readable information output via the speaker 2045.

The embodiments described above are implemented by combinations of components and features of the present invention in predetermined forms. Each component or feature should be considered selectively unless specified separately. Each component or feature may be carried out without being combined with another component or feature. Moreover, some components and/or features are combined with each other and can implement embodiments of the present invention. The order of operations described in embodiments of the present invention may be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present invention can be implemented by various means, for example, hardware, firmware, software, or combinations thereof. When embodiments are implemented by hardware, one embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present invention can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present invention can be embodied in other specific forms without departing from essential features of the present invention. Accordingly, the aforementioned detailed description should not be construed as limiting in all aspects and should be considered as illustrative. The scope of the present invention should be determined by rational construing of the appended claims, and all modifications within an equivalent scope of the present invention are included in the scope of the present invention.

### INDUSTRIAL APPLICABILITY

Although a control method of an aerial control system according to the present invention has been described focusing on examples applying to the 3GPP LTE/LTE-A system and the 5G system, it can be applied to various wireless communication systems other than them.

1. An aerial control system comprising:
an unmanned aerial vehicle;
a communication module configured to exchange information with the unmanned aerial vehicle;
a level determination module configured to determine an autonomous flying level of the unmanned aerial vehicle;
a storing module configured to store information on a flight restricted area in which a flight of the unmanned aerial vehicle is restricted; and
a control module configured to differently calculate an access limit distance of the flight restricted area depending on the autonomous flying level of the unmanned aerial vehicle and provide the unmanned aerial vehicle with the information on the flight restricted area and information on the access limit distance.

2. The aerial control system of claim 1, wherein the access limit distance is set to decrease as the autonomous flying level increases.

3. The aerial control system of claim 1, wherein the access limit distance is differently set depending on a type or a location of the flight restricted area.

4. The aerial control system of claim 1, wherein the unmanned aerial vehicle sets a flight path based on the information on the flight restricted area and the information on the access limit distance.

5. The aerial control system of claim 1, further comprising a location determination module configured to determine a location and an altitude of the unmanned aerial vehicle through location altitude information provided by the unmanned aerial vehicle.

6. The aerial control system of claim 5, wherein if the unmanned aerial vehicle approaches within the access limit distance, the control module sends a different command to the unmanned aerial vehicle depending on the autonomous flying level.

7. The aerial control system of claim 6, wherein if the unmanned aerial vehicle approaches within the access limit distance, the control module sends a flying command that allows the unmanned aerial vehicle to fly along a new flight path out of the access limit distance when the autonomous flying level exceeds a predetermined level.

8. The aerial control system of claim 6, wherein if the unmanned aerial vehicle approaches within the access limit distance, the control module controls the unmanned aerial vehicle to move to a location farther than the access limit distance in the flight restricted area when the autonomous flying level is equal to or less than a predetermined level.

9. The aerial control system of claim 5, further comprising a terminal configured to exchange information with the unmanned aerial vehicle and the communication module and control the unmanned aerial vehicle.

10. The aerial control system of claim 9, wherein if the unmanned aerial vehicle approaches within the access limit distance, the control module controls the terminal to output an access alarm of the flight restricted area.

11. The aerial control system of claim 9, wherein if the unmanned aerial vehicle approaches within the access limit distance, the control module controls the terminal to output a deviation path of the flight restricted area.

12. The aerial control system of claim 9, wherein the level determination module determines an automatic adjustment or a manual adjustment of the unmanned aerial vehicle,
wherein if the unmanned aerial vehicle approaches within the access limit distance, the control module controls the terminal to output an access alarm of the flight restricted area in case of the manual adjustment.

13. The aerial control system of claim 9, wherein the level determination module determines an automatic adjustment or a manual adjustment of the unmanned aerial vehicle,
wherein the control module allows the unmanned aerial vehicle to approach within the access limit distance depending on a level of a user in case of the manual adjustment.

14. The aerial control system of claim 13, wherein if the unmanned aerial vehicle approaches within the access limit distance, the control module controls the unmanned aerial vehicle to be forced to land when the level of the user is equal to or less than a predetermined level in the case of the manual adjustment.

15. An aerial control system comprising:
an unmanned aerial vehicle; and
a server configured to exchange information with the unmanned aerial vehicle,
wherein the server is configured to store information on a flight restricted area in which a flight of the unmanned aerial vehicle is restricted, differently calculate an access limit distance of the flight restricted area depending on an autonomous flying level of the unmanned aerial vehicle, and provide the unmanned aerial vehicle with the information on the flight restricted area and information on the access limit distance.

16. The aerial control system of claim 15, wherein the server is configured to:
set a flight path based on the information on the flight restricted area and the information on the access limit distance; and
provide the flight path to the unmanned aerial vehicle.

17. An aerial control system comprising:
an unmanned aerial vehicle;
a server configured to exchange information with the unmanned aerial vehicle; and
a terminal configured to exchange information with the unmanned aerial vehicle and the server and control the unmanned aerial vehicle,
wherein the server is configured to store information on a flight restricted area in which a flight of the unmanned aerial vehicle is restricted, differently calculate an access limit distance of the flight restricted area depending on an autonomous flying level of the unmanned aerial vehicle, and provide at least one of the unmanned aerial vehicle and the terminal with the information on the flight restricted area and information on the access limit distance.

18. The aerial control system of claim 17, wherein the server is configured to:
set a flight path based on the information on the flight restricted area and the information on the access limit distance; and
provide the flight path to at least one of the unmanned aerial vehicle and the terminal.

19. A base station transmitting and receiving information with an unmanned aerial vehicle, the base station comprising:
a communication module configured to exchange information with the unmanned aerial vehicle;
a level determination module configured to determine an autonomous flying level of the unmanned aerial vehicle;
a storing module configured to store information on a flight restricted area in which a flight of the unmanned aerial vehicle is restricted; and
a control module configured to differently calculate an access limit distance of the flight restricted area depending on the autonomous flying level of the unmanned aerial vehicle and provide the unmanned aerial vehicle with the information on the flight restricted area and information on the access limit distance.

20. An unmanned aerial vehicle comprising:
a communication module configured to receive, from a base station, measurement configuration information and information on an access limit distance of a flight restricted area and transmit a measurement report to the base station; and
a processor functionally connected to the communication module,
wherein the processor is configured to:
perform a measurement based on the measurement configuration information;
control the communication module to transmit the measurement report to the base station, if a first event condition included in the measurement configuration information is satisfied; and
control the measurement report to include information informing that it is located in the flight restricted area, if a distance related to the first event condition corresponds to the access limit distance of the flight restricted area.

21. The unmanned aerial vehicle of claim 20, wherein the access limit distance of the flight restricted area is determined depending on an autonomous flying level.

22. The unmanned aerial vehicle of claim 20, wherein the first event condition is Ms+Hys<Thresh+Offset.

23. The unmanned aerial vehicle of claim 20, wherein the measurement report further includes at least one of location altitude information or flight path information.

24. The unmanned aerial vehicle of claim 20, wherein the processor is configured to control the communication module to receive downlink control information (DCI) used to schedule a transmission of the measurement report from the base station,
wherein the measurement report is transmitted to the base station based on the DCI.

25. The unmanned aerial vehicle of claim 20, wherein the processor is configured to perform an initial connection procedure with the base station based on a synchronization signal block (SSB),
wherein the measurement report is transmitted via a PUSCH,
wherein the SSB and a DM-RS of the PUSCH are quasi co-located (QCL) with respect to QCL type D.

26. The unmanned aerial vehicle of claim 20, further comprising a photographing module configured to collect real-time information,
wherein the processor is configured to control the communication module to transmit the real-time information to an AI system and control the communication module to receive processed information from the AI system.

27. The unmanned aerial vehicle of claim 26, wherein the real-time information includes at least one of high precision three dimensional surface topography data, a real-time photo, or a real-time video.
